(19) United States
(12) Patent Application Publication
(10) Pub. No.: US 2015/0340043 A1
(43) Pub. Date: Nov. 26, 2015

(54) MULTICHANNEL ENCODER AND DECODER WITH EFFICIENT TRANSMISSION OF POSITION INFORMATION

(71) Applicant: KONINKLIJKE PHILIPS N.V., Eindhoven (NL)

(72) Inventors: Jeroen Gerardus Henricus KOPPENS, Nederweert (NL); Arnoldus Werner Johannes OOMEN, Eindhoven (NL); Erik Gosuinus Petrus SCHUIJERS, Breda (NL)

(21) Appl. No.: 14/652,953

(22) PCT Filed: Jan. 8, 2014
(86) PCT No.: PCT/IB2014/058120

§ 371 Date: Jun. 17, 2015

Related U.S. Application Data
(60) Provisional application No. 61/751,986, filed on Jan. 14, 2013.

(51) Int. Cl. G10L 19/008

(52) U.S. Cl. CPC G10L 19/008

(57) ABSTRACT

A receiver (603) receives a position given by a first value representing a first position parameter and a second value representing a second position parameter. A match circuit (605) determines if the second value matches a nominal value. If so, an output circuit (609) generates output data including data representing the first value in a field of the output data but not including data representing the second value in the output data. Otherwise, the output circuit (609) includes data in the field which represents an invalid position value for the first position parameter. A receiver determines if data of a data field represents a valid position value for the first position parameter. If so, it determines a position with the first value being the valid position value and the second value being a nominal value for the second position parameter. Otherwise it determines the second value from a second field of the input data.

### FIELD OF THE INVENTION

The invention relates to communication of position information and in particular, but not exclusively, to communication of position data for audio processing applications.

### BACKGROUND OF THE INVENTION

Digital encoding of various source signals has become increasingly important over the last decades as digital signal representation and communication increasingly has replaced analogue representation and communication. For example, audio content, such as speech and music, is increasingly based on digital content encoding. Furthermore, audio consumption has increasingly become an enveloping three dimensional experience with e.g. surround sound and home cinema setups becoming prevalent.

Audio encoding formats have been developed to provide increasingly capable, varied and flexible audio services and in particular audio encoding formats supporting spatial audio services have been developed.

Well known audio coding technologies like DTS and Dolby Digital produce a coded multi-channel audio signal that represents the spatial image as a number of channels that are placed around the listener at fixed positions. For a speaker setup which is different from the setup that corresponds to the multi-channel signal, the spatial image will be suboptimal. Also, channel based audio coding systems are typically not able to cope with a different number of speakers.

(MPEG-D) MPEG Surround provides a multi-channel audio coding tool that allows existing mono- or stereo-based coders to be extended to multi-channel audio applications. FIG. 1 illustrates an example of elements of an MPEG Surround system. Using spatial parameters obtained by analysis of the original multichannel input, an MPEG Surround decoder can recreate the spatial image by a controlled upmix of the mono- or stereo signal to obtain a multichannel output signal.

Since the spatial image of the multi-channel input signal is parameterized, MPEG Surround allows for decoding of the same multi-channel bit-stream by rendering devices that do not use a multichannel speaker setup. An example is virtual surround reproduction on headphones, which is referred to as the MPEG Surround binaural decoding process. In this mode a realistic surround experience can be provided while using regular headphones. Another example is the pruning of higher order multichannel outputs, e.g. 7.1 channels, to lower order setups, e.g. 5.1 channels.

Indeed, the variation and flexibility in the rendering configurations used for rendering spatial sound has increased significantly in recent years with more and more reproduction formats becoming available to the mainstream consumer. This requires flexible representation of audio. Important steps have been taken with the introduction of the MPEG Surround codec. Nevertheless, audio is still produced and transmitted for a specific loudspeaker setup. Reproduction over different setups and over non-standard (i.e. flexible or user-defined) speaker setups is not specified. Indeed, there is a desire to make audio encoding and representation increasingly independent of specific predetermined and nominal speaker setups. It is increasingly preferred that flexible adaptation to a wide variety of different speaker setups can be performed at the decoder/rendering side.

In order to provide for a more flexible representation of audio, MPEG standardized a format known as ‘Spatial Audio Object Coding’ (MPEG-D SAOC). In contrast to multichannel audio coding systems such as DTS, Dolby Digital and MPEG Surround, SAOC provides efficient coding of individual audio objects rather than audio channels. By means of a rendering matrix individual sound objects are mapped onto speaker channels. Whereas in MPEG Surround, each speaker channel can be considered to originate from a different mix of sound objects, SAOC makes individual sound objects available at the decoder side for interactive manipulation as illustrated in FIG. 2. In SAOC, multiple sound objects are coded into a mono or stereo downmix together with parametric data allowing the sound objects to be extracted at the rendering side thereby allowing the individual audio objects to be available for manipulation e.g. by the end-user.

Indeed, similarly to MPEG Surround, SAOC also creates a mono or stereo downmix. In addition, object parameters are calculated and included. At the decoder side, the user may manipulate these parameters to control various features of the individual objects, such as position, level, equalization, or even to apply effects such as reverb. FIG. 3 illustrates an interactive interface that enables the user to control the individual objects contained in an SAOC bitstream.

SAOC allows a more flexible approach and in particular allows more rendering based adaptability by transmitting audio objects instead of only reproduction channels. This allows the decoder-side to place the audio objects at arbitrary positions in space, provided that the space is adequately covered by speakers. This way there is no relation between the transmitted audio and the reproduction or rendering setup, hence arbitrary speaker setups can be used. This is advantageous for e.g. home cinema setups in a typical living room, where the speakers are almost never at the intended positions. In SAOC, it is decided at the decoder side where the objects are placed in the sound scene, which is often not desired from an artistic point-of-view. The SAOC standard does provide ways to transmit a default rendering matrix in the bitstream, eliminating the decoder responsibility. However the provided methods rely on either fixed reproduction setups or on unspecified syntax. Thus SAOC does not provide normative means to fully transmit an audio scene independently of the speaker setup. Also, SAOC is not well equipped to the faithful rendering of diffuse signal components. Although there is the possibility to include a so called multichannel background object to capture the diffuse sound, this object is tied to one specific speaker configuration, such as e.g. a 5.1 surround speaker setup.

Another specification for an audio format for 3D audio is being developed by the 3D Audio Alliance (3DAA) which is an industry alliance. 3DAA is dedicated to develop standards for the transmission of 3D audio, that “will facilitate the transition from the current speaker feed paradigm to a flexible object-based approach”. In 3DAA, a bitstream format is to be defined that allows the transmission of a legacy multichannel downmix along with individual sound objects. In addition, object positioning data is included. The principle of generating a 3DAA audio stream is illustrated in FIG. 4.

In the 3DAA approach, the sound objects are received separately in the extension stream and these may be extracted from the multi-channel downmix. The resulting multi-channel downmix is rendered together with the individually available objects.

The objects may consist of so called stems. These stems are basically grouped (downmixed) tracks or objects. Hence, an object may consist of multiple sub-objects packed into a stem. In 3DAA, a multichannel reference mix can be transmitted with a selection of audio objects. 3DAA transmits the 3D positional data for each object. The objects can then be extracted using the 3D positional data. Alternatively, the inverse mix-matrix may be transmitted, describing the relation between the objects and the reference mix.

From the description of 3DAA, sound-scene information is likely transmitted by assigning an angle and distance to each object, indicating where the object should be placed relative to e.g. the default forward direction. Thus, positional information is transmitted for each object. This is useful for point-sources but fails to describe wide sources (like e.g. a choir or applause) or diffuse sound fields (such as ambiance). When all point-sources are extracted from the reference mix, an ambient multichannel mix remains. Similar to SAOC, the residual in 3DAA is fixed to a specific speaker setup.

Thus, both the SAOC and 3DAA approaches incorporate the transmission of individual audio objects that can be individually manipulated at the decoder side. A difference between the two approaches is that SAOC provides information on the audio objects by providing parameters characterizing the objects relative to the downmix (i.e. such that the audio objects are generated from the downmix at the decoder side) whereas 3DAA provides audio objects as full and separate audio objects (i.e. that can be generated independently from the downmix at the decoder side). For both approaches, position data may be communicated for the audio objects.

A significant difference between traditional and the new approaches for audio encoding and distribution is that the traditional approaches inherently assumed a specific speaker configuration. Thus, the positions of each of the speakers is (assumed) to be known for these approaches. Furthermore, the audio is encoded and distributed as audio signals for the individual speakers, and thus the audio signals are generated to be rendered from the known rendering positions, and such that when the signals are rendered from these positions, the resulting sound will produce a spatial perception with sound sources at the desired positions. As a consequence of this approach, only the audio signals for the individual speakers need to be communicated and no positional information is required.

However, for newer approaches, such assumptions cannot be made, and it is accordingly required or desired that positional data is also communicated.

For example, positional information relating to the desired or suggested position of audio objects should be communicated. As another example, it may be desirable for the desired speaker positions (or e.g. positions of microphones capturing a signal) to be communicated such that a renderer can take such positions into account when generating a spatial sound scene from a given rendering configuration which is unknown at the time of encoding. Another example is when support is provided for binaural virtual sound rendering, such as when using HRTF processing for rendering spatial audio via headphones. In this case, positional information may be communicated in order for the binaural renderer to select the appropriate HRTF filters corresponding to a desired position.

However, communication of the position data introduces an overhead to the communication of the audio information and specifically results in a higher data rate than otherwise. It is desirable to reduce this overhead as much as possible, and thus an efficient representation and communication of the position data is desired.

Hence, an improved approach would be advantageous and in particular an approach allowing improved representation and communication of position information, reduced data rate, reduced overhead, facilitated implementation, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for communicating a position, the apparatus comprising:

a receiver for receiving a position, the position having at least a first value and a second value, the first value representing a first position parameter and the second value representing a second position parameter; a match circuit for determining if the second value matches a nominal value for the second position parameter; an output circuit for generating output data, the output circuit being arranged to: when the second value matches the nominal value, including first data representing the first value in a first field of the output data but not including data representing the second value in the output data; and when the second value does not match the nominal value, including second data in the first field, the second data representing an invalid position value for the first position parameter.

The invention may allow improved communication of a position. In particular, one or more positions may be communicated with reduced overhead. A data rate required for communicating audio data and associated position information may be reduced in many embodiments and scenarios. This may in many embodiments be achieved without restricting the range of positions that can be communicated.

The approach is based on the Inventors' realization that improved representation and communication of positions in many scenarios advantageously can be achieved by allowing a position to sometimes be indicated by fewer values than the number of parameters used to describe the position. For example, a three dimensional position may be represented by a single value or two values. This may be achieved by using nominal values for at least one of the components. The nominal values may be known both at the transmitter and at a receiver. However, the approach furthermore allows for the positions that can be communicated to not be limited to positions that only vary in one parameter. Rather, the data of a data field can be dynamically varied to represent values of a first position parameter assuming nominal values for at least one other position parameter or to represent indications that the nominal values cannot be used for this other position parameter. Specifically, the first data field can comprise data indicating the value of the first position parameter or can indicate whether the assumption of the second communication parameter having the nominal value is valid or not.

The approach may allow a low complexity syntax for the representation. It may allow a very compact representation of positions resulting in substantially reduced overhead. Indeed, many positions may be indicated by a single value but without restricting the position to a single dimension. Rather, full two dimensional or three dimensional positions can be communicated with more than one value only being communicated when necessary.

The first and second position parameters may represent different components of a representation of a position, and in particular of a two dimensional or three dimensional position. For example, the position may be given as a vector with two or three elements and the first and second parameters may correspond to a first and second element of the position vector.

For example, the first position parameter may be an azimuth angle and the second position parameter may be an elevation angle or a distance.

The determination of whether the second value matches the nominal value may be in accordance with a match criterion. It will be appreciated that any suitable match criterion may be used. For example, the second value may be considered to match the nominal value if the (absolute) difference between them is less than a threshold.

The nominal value may be an initial value, a predetermined value or e.g. a value of the second position parameter for a previous position.

A set of valid values for the first position parameter may be (pre) defined, and the invalid position value may be a value that is not included in this set. The set may be given as a range of valid values.

In some embodiments, the second data is indicative of a type of data being provided in a second field of the output data.

The first field may be any field of the output data. The second field may be any other field of the output data.

In some embodiments, the second data is indicative of the second field comprising an indication of a predetermined set of positions.

In some embodiments, the position is further given by a third value representing third position parameter, and the second data is indicative of whether the second field comprises a position value for the second position parameter or the third position parameter.

In some embodiments, the second data is indicative of a relative difference between pairs of at least three positions.

In some embodiments, the first position parameter is associated with a range of possible values and the invalid position value is a value outside the range.

In some embodiments, the second position parameter is a distance parameter or elevation parameter.

In some embodiments, the position is at least one of: a speaker position; a sound source position; and a virtual sound source position for a Head Related Transfer Function.

In accordance with an optional feature of the invention, the output circuit is arranged to, when the second value does not match the nominal value, include data representing the second value in a second field of the output data.

The approach may allow an efficient approach for providing and communicating position information.

In accordance with an optional feature of the invention, the output circuit is arranged to, when the second value does not match the nominal value, set the nominal value to the second value.

The nominal value may be used for a subsequent position, i.e. for communicating subsequent positions using the same approach but with the updated nominal value. Specifically, the receiver may receive a second position, the position having at least a third value and a fourth value, the third value representing the first position parameter and the fourth value representing the second position parameter. The match circuit can determine if the fourth value matches the nominal value (after this has been updated). The output circuit is further arranged to, when the fourth value matches the nominal value, include data representing the third value in a second field of the output data but not including data representing the fourth value in the output data. When the fourth value does not match the nominal value, the output circuit includes data in the second field which represents an invalid position value for the first position parameter.

The approach may allow an efficient representation of positions, and may in particular in many applications result in a low overhead while allowing a non-restricted position representation.

In accordance with an optional feature of the invention, the output circuit is arranged to, when the second value does not match the nominal value, include data representing the first value in a third field of the output data.

The approach may allow an efficient approach for providing and communicating position information.

In accordance with an aspect of the invention, there is provided an apparatus for receiving a position given by at least a first value and a second value, the first value representing a first position parameter and the second value representing a second position parameter, the apparatus comprising: a receiver for receiving input data comprising a plurality of data fields; a data extractor for extracting first data from a first field of the plurality of data fields; a validity circuit for determining if the first data represents a valid position value for the first position parameter; a position circuit for determining the position, the position processor being arranged to: when the first data represents a valid position value, determining the first value as the valid position value and the second value as a nominal value for the second position parameter; and when the first data does not represent a valid position value, determining the second value from a second field of the input data.

The invention may allow improved communication of a position. In particular, one or more positions may be communicated with reduced overhead. A data rate required for communicating audio data and associated position information may be reduced in many embodiments and scenarios. This may in many embodiments be achieved without restricting the range of positions that can be communicated.

The approach is based on the Inventors' realization that improved representation and communication of positions in many scenarios advantageously can be achieved by allowing a position to sometimes be indicated by fewer values than the number of parameters used to describe the position. For example, a three dimensional position may be represented by a single value or two values. This may be achieved by using nominal values for at least one of the components. The nominal values may be known both at the transmitter and at a receiver. However, the approach furthermore allows for the positions that can be communicated to not be limited to positions that only vary in one parameter. Rather, the data of a data field can be dynamically varied to represent values of a first position parameter assuming nominal values for at least one other position parameter or to represent indications that the nominal values cannot be used for this other position parameter. Specifically, the first data field can comprise data indicating the value of the first position parameter or can indicate whether the assumption of the second communication parameter having the nominal value is valid or not.

The approach may allow an efficient and/or low complexity syntax for the representation. It may allow a very compact representation of positions resulting in substantially reduced overhead. Indeed, many positions may be indicated by a single value but without restricting the position to a single dimension. Rather, full two dimensional or three dimensional positions can be communicated using only one value for many positions and with more than one value only being communicated when necessary.

The first and second position parameters may represent different components of a representation of a position, and in particular of a two dimensional or three dimensional position. For example, the position may be given as a vector with two or three elements and the first and second parameters may correspond to a first and second element of the position vector.

For example, the first position parameter may be an azimuth angle and the second position parameter may be an elevation angle or a distance.

The determination of whether the first data represents a valid position value may be in accordance with a validity criterion. It will be appreciated that any suitable validity criterion may be used. A set of valid values for the first position parameter may be (pre) defined, and the invalid position value may be a value not included in this set.

The nominal value may be an initial value, a predetermined value or e.g. a value of the second position parameter received for a previous position.

When the first data does not represent a valid position value, the first value may in many embodiments be determined from a third field of the input data.

In accordance with an optional feature of the invention, the position circuit is arranged to, when the first data does not represent a valid position value, set the nominal value to the second value.

The (new) nominal value may then be used for extracting subsequent positions. E.g. for the next position, the same approach may be used to decode the data but with the new nominal value being used. Specifically, the data extractor may extract second data from a second field of the input data. The validity circuit may determine if the second data represents a valid position value for the first position parameter. The position circuit may, when the second data represents a valid position value, determine a third value for the first position parameter of a new position as the valid position value and the fourth value for the second position parameter of the new position as the (new) nominal value. The position circuit may, when the first data does not represent a valid position value, determine the fourth value from a third field of the input data.

The approach may allow an efficient representation of positions, and may in particularly in many applications result in a low overhead while at the same time not restricting the positions that can be communicated. In particular, the approach may allow any type of position to be communicated while at the same time substantially providing the communication efficiency that can be achieved when positions are restricted to have specific characteristics, such as a specific elevation or distance.

In accordance with an optional feature of the invention, the first data is indicative of a type of data being provided in the second field of the output data.

This may allow a particularly efficient and flexible representation and communication of one or more positions.

In accordance with an optional feature of the invention, the first data does not represent a valid position value, the first data is indicative of the second field comprising an indication of a predetermined set of positions; and the position processor is arranged to determine at least the first value in response to the predetermined set of positions.

This may allow a particularly efficient and flexible representation and communication of a plurality of positions.

In accordance with an optional feature of the invention, the position is further given by a third value representing third position parameter and, when the first data does not represent a valid position value, the first data is indicative of whether the second field comprises a position value for the second position parameter or a position value for the third position parameter.

This may allow a particularly efficient and flexible representation and communication of one or more positions. It may allow an efficient representation in particular for three dimensional positions where two parameters typically do not change as often (between positions) as a third parameter. The first position parameter may specifically be an azimuth parameter and the second and third position parameters may for example be an elevation parameter and distance parameter respectively.

In accordance with an optional feature of the invention, the first data does not represent a valid position value, the first data is indicative of the second field comprises data indicative of a relative difference between pairs of at least three positions; and the position processor is arranged to determine at least the first value in response to the relative difference between pairs of at least three positions.

This may allow a particularly efficient and flexible representation and communication of a plurality of positions.

In accordance with an optional feature of the invention, the first position parameter is associated with a range of possible values and the invalid position value is a value outside the range.

This may allow a particularly advantageous approach for determining and representing invalid position parameters. In particular, it may allow easy detection and representation of invalid values while allowing a full representation of positions in a given range. The approach may be particularly suitable for embodiments wherein the first position parameter may be an angular direction as such positions are inherently typically associated with a specific range of values.

In accordance with an optional feature of the invention, the second position parameter is one of a distance parameter and an elevation parameter.

The invention may provide particularly advantageous operation for embodiments wherein the position is represented e.g. by an azimuth and distance and/or elevation. In such embodiments, many e.g. audio applications may use positions with typically different azimuths but with large sets sharing elevation and/or distance. Such a collection of positions may be communicated very efficiently using the described approach.

In accordance with an optional feature of the invention, the position is at least one of: a speaker position; a sound source position; and a virtual sound source position for a Head Related Transfer Function.

The approach may provide a very efficient representation and communication of audio positions, such as virtual sound source positions, speaker positions, and other sound source positions, such as desired rendering positions for audio objects.

According to an aspect of the invention there is provided a method of communicating a position, the method comprising: receiving a position, the position having at least a first value and a second value, the first value representing a first position parameter and the second value representing a second position parameter; determining if the second value matches a nominal value for the second position parameter; generating output data; wherein generating the output data comprises: when the second value matches the nominal value, including first data representing the first value in a first field of the output data but not including data representing the second value in the output data; and when the second value does not match the nominal value, including second data in the first field, the second data representing an invalid position value for the first position parameter.

According to an aspect of the invention there is provided a method of receiving a position given by at least a first value and a second value, the first value representing a first position parameter and the second value representing a second position parameter, the method comprising: receiving input data comprising a plurality of data fields; extracting first data from a first field of the plurality of data fields; determining if the first data represents a valid position value for the first position parameter; determining the position; wherein determining the position comprises: when the first data represents a valid position value, determining the first value as the valid position value and the second value as a nominal value for the second position parameter; and when the first data does not represent a valid position value, determining the second value from a second field of the input data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of elements of an MPEG Surround system;

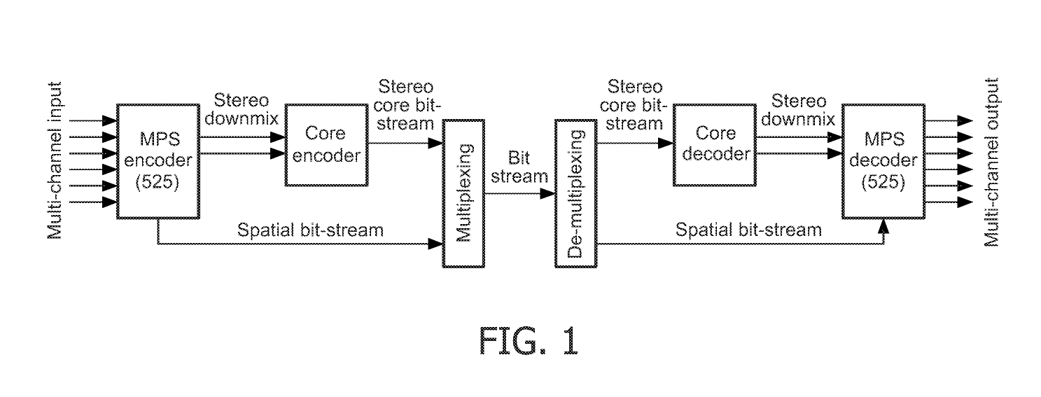

FIG. 2 exemplifies the manipulation of audio objects possible in MPEG SAOC;

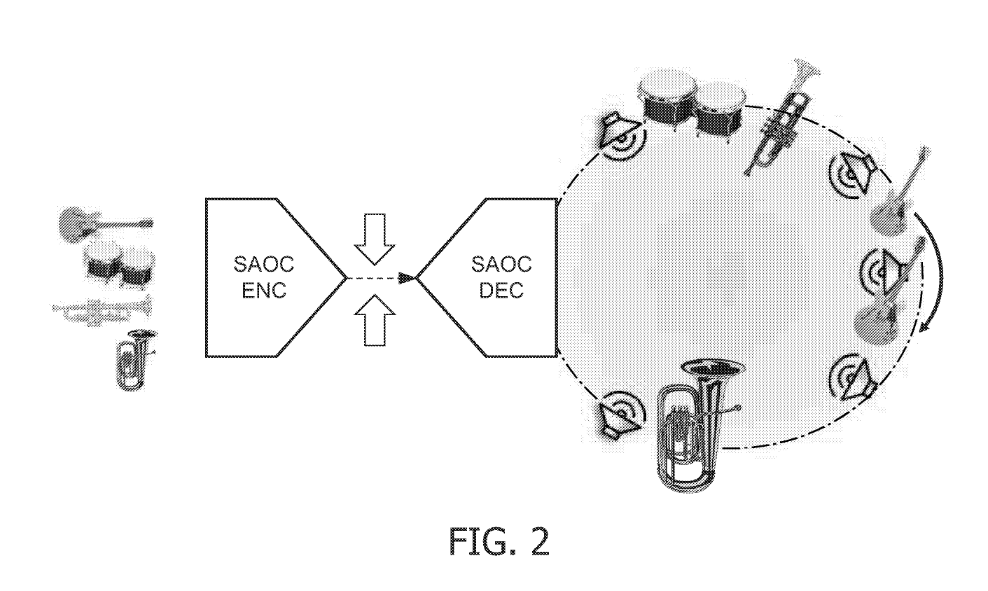

FIG. 3 illustrates an interactive interface that enables the user to control the individual objects contained in an SAOC bitstream;

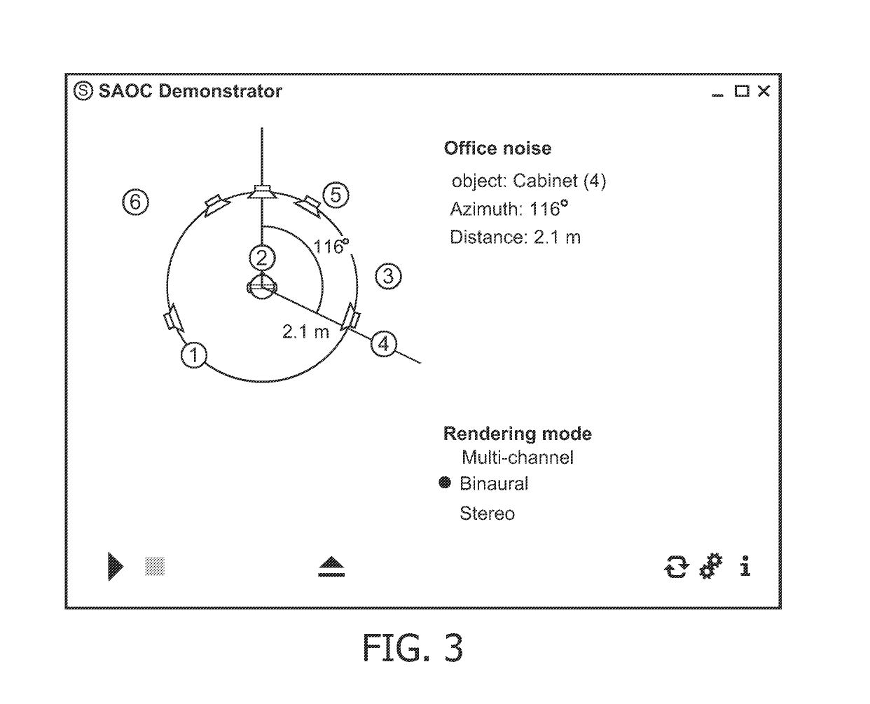

FIG. 4 illustrates an example of the principle of audio encoding of 3DAA;

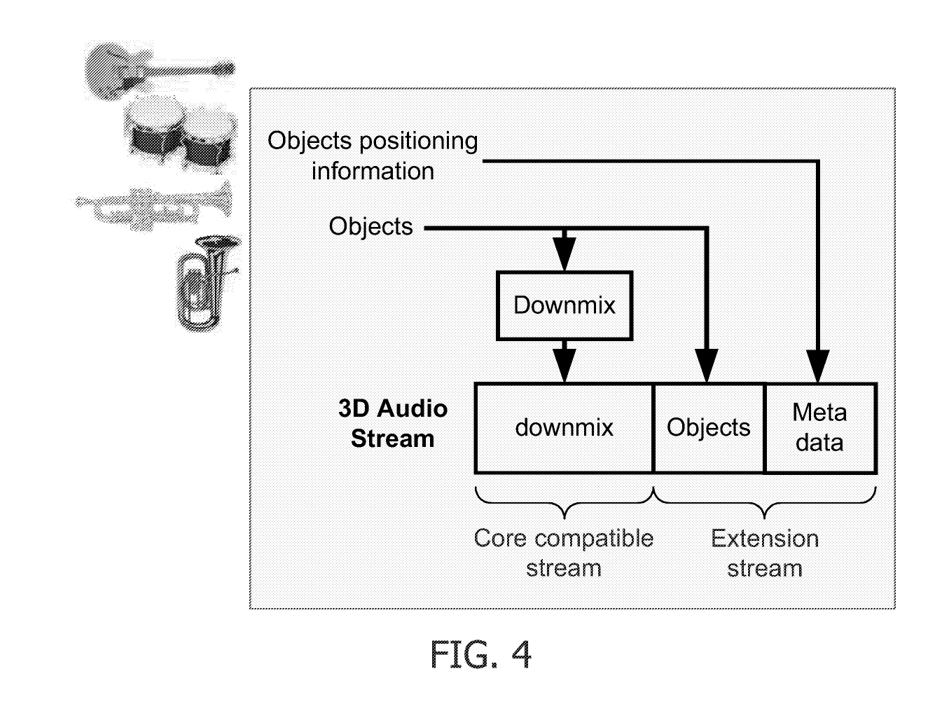

FIG. 5 illustrates an example of binaural processing;

FIG. 6 illustrates an example of a transmitter of position data in accordance with some embodiments of the invention; and

FIG. 7 illustrates an example of a receiver of position data in accordance with some embodiments of the invention.

### DETAILED DESCRIPTION OF SOME EMBODIMENTS OF THE INVENTION

The following description focuses on embodiments of the invention applicable to communication of sound source positions, and in particular to communication of virtual sound source positions for binaural rendering using Head Related Transfer Function, HRTF, (or equivalent) algorithms. However, it will be appreciated that the invention is not limited to this application but may be applied to communication of many other types of positions.

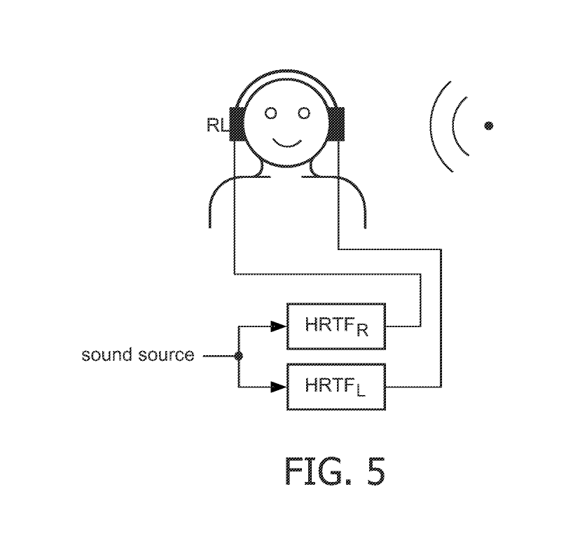

Binaural processing where a spatial experience is created by virtual positioning of sound sources is become increasingly widespread. Virtual surround is a method of rendering the sound with HRTFs such that audio sources are perceived as originating from a specific direction, thereby creating the illusion of listening to a physical surround sound setup (e.g. 5.1 speakers) or environment (concert). With an appropriate HRTF, the signals required at the eardrums for the listener to perceive sound from any direction can be calculated. As illustrated in FIG. 5, these signals are then recreated at the eardrum using either headphones or a crosstalk cancelation method (suitable for rendering over closely spaced speakers).

Next to the direct rendering of FIG. 5, specific technologies that can be used to render virtual surround include MPEG Surround and Spatial Audio Object Coding, as well as the upcoming work item on 3D Audio in ISO/IEC MPEG. These technologies provide for a computationally efficient virtual surround rendering.

By measuring the impulse responses from a sound source at a specific location in 2D or 3D space at microphones placed in or near the ears, so called Head Related Impulse Responses (HRIR) or equivalently HRTFs can be determined. HRTFs (in the following the term will be used to include HRIRs and indeed Binaural Room Impulse Response (BRIRs) etc.) can be used to create a binaural recording simulating multiple sources at various locations. This can be realized by filtering each sound source with the pair of HRTFs that correspond to the position of the sound source. In order to allow a sound source to move around the listener, a large number of HRTFs is required with adequate spatial resolution. HRTF filters are often associated with a specific (virtual) source position indicated by an azimuthal angle, an elevation angle and a distance from the sweet-spot.

In order to control the rendering of audio objects, a transmitter/encoder may transmit positions of the individual audio objects allowing the renderer to select the appropriate HRTFs. However, such an approach adds an overhead as the position information needs to be communicated in addition to the audio data itself.

Indeed, in more recent standards, audio data may be provided which is independent of the rendering configuration, and accordingly which are not linked to any specific nominal or assumed rendering configuration. For such audio data, position information may be provided allowing the encoder/transmitter side to specify e.g. a desired spatial experience. The renderer can then adapt the processing depending on the local speaker configuration such that the audio is presented as prescribed by the positional data. E.g. the audio data may include a number of sound source positions for audio objects, and the renderer may use the received sound source position data to adapt the rendering such that audio objects are perceived to originate from the desired direction. In some embodiments, sound source positional data defining assumed speaker positions, either for the rendering configuration or for a desired reference setup, may be communicated.

In order to minimize the overhead resulting from the requirement to include positional information, it is important that the positions are efficiently represented and encoded in the communicated data stream/signal.

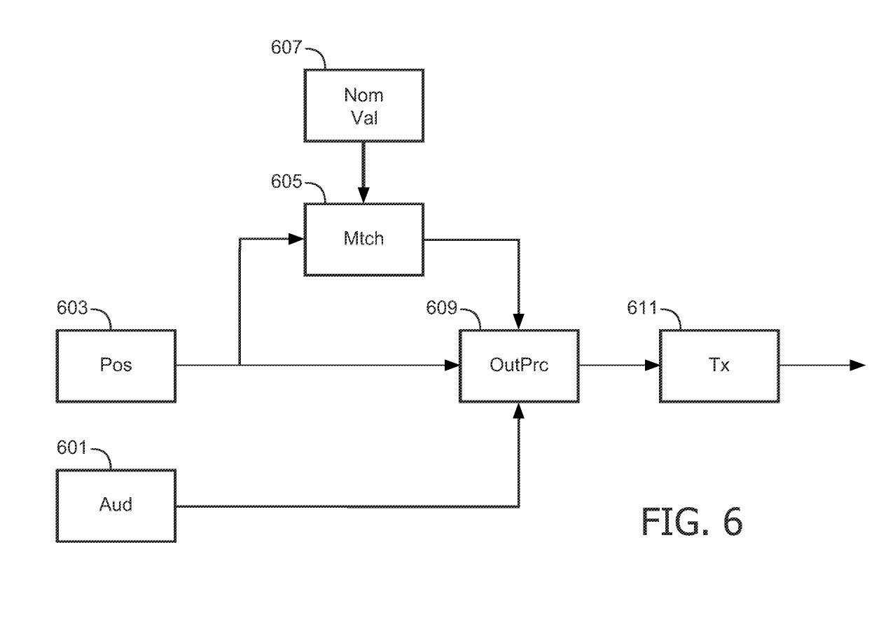

FIG. 6 illustrates an example of a transmitter for communicating position information, and in particular for communicating audio data together with associated position information.

The transmitter comprises an audio processor 601 which receives or generates audio data. The audio data may for example include audio channels, audio objects, background audio etc. The audio data may be generated from recorded audio or may e.g. be synthetically generated.

The transmitter further comprises a position receiver 603 which receives one or more positions that are to be communicated together with the audio. As mentioned, the positions may be sound source positions, such as virtual sound source positions for binaural rendering, desired positions for audio channels or audio objects, or speaker positions etc.

The position receiver 603 may receive the position information from any internal or external source. For example, the position receiver 603 may be implemented as firmware operation receiving the position data from subroutines. Indeed, in some embodiments, a virtual sound stage may be rendered based on e.g. a three dimensional model. The audio may be provided to or generated by the audio processor 601, and the position information may be provided to the position receiver 603 from the audio processor 601.

Each of the positions is given by values of a plurality of parameters (position variables). Thus, each position may be given as a set of values where each component of the set corresponds to a given parameter. For example, the positions may be given as a two dimensional position represented by values of a first and second parameter or may be given as a three dimensional position represented by values of a first, second and third parameter. Thus, the positions are given as at least a first value representing a first position parameter and a second value representing a second position parameter.

In the following examples, the first position parameter corresponds to an azimuth angle, and the second and third position parameters correspond to elevation angle and distance (or vice versa). Thus each of the positions is given by an azimuth angle, an elevation angle and a distance. Thus, in the example the azimuth value is a first value of the position and it provides a value for the first position parameter, which in this case is an azimuth parameter. The elevation angle is a second value of the position, and it provides a value for the second position parameter which in this case is an elevation angle parameter. The distance value is a third value of the position, and it provides a value for the third position parameter which in this case is a distance parameter. It will be appreciated that in many scenarios, the distance may equivalently be considered to be the second value for the second position parameter (i.e. the second position parameter may be considered to be a distance measure or property).

It will be appreciated that in other embodiments, other parameters may be used to represent a position, such as e.g. three coordinates of a Euclidian coordinate system (e.g. xyz values) or coordinates from other coordinate systems.

The position receiver 603 is coupled to a match processor 605 which is further coupled to a nominal value memory 607. The nominal value memory 607 is arranged to store a nominal value for at least the second position parameter, i.e. in the specific example for either the distance or elevation. Upon initialization of the system, a predetermined nominal value may be stored in the nominal value memory 607. For example, a nominal value for the elevation angle of 0° and a distance of 1.5 meters may be stored as nominal values.

For each position that is to be transmitted, the match processor 605 receives the values of the different position parameters. Specifically, the match processor 605 may receive the elevation angle and the distance for the position, corresponding to receiving a second value of the position. It then proceeds to compare the received values to the stored nominal positional values. The match processor 605 may then generate a match indication that indicates whether the current values of the position match the stored nominal values. This may be considered to be the case if the values are sufficiently similar, e.g. if the absolute value of the difference between the stored value and the current value is below a threshold. It will be appreciated that other match criteria can be used in other embodiments.

In the specific example, the match processor 605 generates independent match indications for the two parameters of the elevation and the distance, i.e. it may generate independent match indications for the second and third position parameters. However, it will be appreciated that in other embodiments, only a single match indication may be generated. E.g. in some embodiments, one parameter, e.g. the elevation, may always be considered constant (i.e. the system may be restricted to provide only two dimensional positions in a horizontal plane). In such a case, only the distance may be considered by the match processor 605. In yet other embodiments, a combined match indication may be generated, e.g. a binary value may indicate that both the elevation and distance matches the nominal values, or that at least one of them does not match the nominal values.

The match processor 605 is coupled to an output processor 609 which receives the match indication(s). The output processor 609 is furthermore coupled to the position receiver 603 and it receives the values of the positions from this. In addition, the output processor 609 is coupled to the audio receiver 601 from which it receives the audio data. The output processor 609 is arranged to generate an output data signal/bitstream which is fed to a transmitter 611 which is arranged to transmit the resulting output data signal to a suitable receiver.

The transmitter may in the example transmit the output data signal to a remote receiver, e.g. via a wireless communication link, the Internet or indeed using any suitable communication medium. In many embodiments, the output data may be generated as a data or bitstream which can be transmitted to receivers. In other embodiments, the output data signal/bitstream may be stored as a data file and communicated as a data file. For example, the data file may be stored on a suitable medium, such as a memory card, CD, etc.

The output data will include the audio data received from the audio processor 601. In addition, it will include position data that allows the receiver to recover the positions. However, rather than merely including data representing all the values of the positions, the output processor 609 proceeds to provide a dynamically variable and selective representation of the position. Specifically, the output processor 609 is arranged to leave out some of the position parameters and to only include them when it is considered necessary. Furthermore, the output processor 609 utilizes a data structure for the output data which provides a particularly efficient representation of such varying data, and in particularly uses an approach that results in very little overhead for many applications, and in particular when applied to audio applications.

In particular, when the match indication for a position parameter indicates that the second value for the second position parameter matches the nominal value, the output data is generated to not include any data representing the second position parameter.

Specifically, if the elevation value for a first position is the same as the nominal elevation value, the output processor 609 proceeds to not include any data specifying the elevation value for the first position in the data.

Similarly, if the distance value for the first position is the same as the nominal distance value, the output processor 609 proceeds to not include any data specifying the distance value for the first position in the data.

The output processor 609 generates the bitstream to comprise a number of individual fields. In the example, each field may contain a single value. The output processor 609 generates the bitstream to include one, two or three (in case of three dimensional positions) values of the position, and may accordingly generate one, two or three position value fields for each position. The output processor 609 generates at least one data field for each position. This field may be denoted the first field. The first field may be any field of the bitstream. If two fields are generated, the next field may be denoted the second field. The second field may be any field of the bitstream except for the first field. If three fields are generated, the next field may be denoted the third field. The third field may be any field of the bitstream except for the first and second fields. It should be appreciated that these labels do not imply any sequence or ordering of the fields, whether in time or sequence in the bitstream, but are merely labels used for clarity.

In situations where the second and third position parameter values correspond to the nominal values, the first data field is used to convey the first value which is for the first position parameter. Thus, specifically, for positions where the elevation and the distance have the nominal values, the output processor 609 proceeds to generate data that represents the azimuth value and to put this in the only data field which is generated for the position, i.e. in the first field.

However, if the match indication for either of the second and the third position parameter values does not indicate a match, the output processor 609 proceeds to instead provide an invalid position value for the first position parameter in the first field. Thus, in the scenario where at least one of the elevation and the distance values do not match the stored nominal values, the output processor 609 proceeds to use the same data field but instead of entering data describing the actual value for the azimuth, it proceeds to enter a value which the first position parameter cannot attain, i.e. it proceeds to include an invalid azimuth value. Thus, in this case the output processor 609 proceeds to include data in the first field which represents an invalid position value for the first position parameter

As an example, the first field may be specified to contain a numeric value. Furthermore, a range of possible values may have been pre-assigned to the first position parameter. For example, it may have been defined that the azimuth value must be in the interval from [0; 360°]. In this case, the output processor 609 may receive an azimuth value which is in the range from [0; 360°] (or which is converted to this range). If the elevation and the distance values correspond to the nominal values, the output processor 609 proceeds to include the received azimuth value in the first field. Accordingly, the first field will contain a value between 0 and 360° (both inclusive). However, if one of the match indications indicate that one of the values do not match the stored nominal value, the output processor 609 proceeds to enter a value into the first field which is outside the range of [0; 360°].

The approach may allow a very efficient representation of positions in many scenarios. For example, a plurality of positions may need to be encoded. The output data stream may be made up of a number of consecutive data fields which may have the same size, and indeed may be specified to be identical. E.g. the output data stream may include a part which is made up of a sequence of identical data fields, each data field containing a single numeric value in accordance with a given representation (e.g. represented as a simple binary value, as a floating point rational number etc.).

In the system, the positions may be received by the output processor 609 and as long as the elevation and distance are the same as the nominal values, the output processor 609 will proceed to simply put the azimuth value of the next position into the next data field. Thus, a series of consecutive data fields are generated which represent the received positions as a string of value with each value corresponding to one position is generated. In other words, only a first field is generated for each position and this first field comprises data representing the first value, i.e. the value for the first position parameter (in the specific example, an azimuth value). Thus, the positions may be represented without any additional overhead, and indeed with only a single value in a single field being communicated for each position. Assuming that the receiver has information of the nominal values, it can reinstate the missing elevation and distance values in order to generate the original three dimensional positions.

Thus, as long as the received positions have elevation and distance values corresponding to the nominal values (i.e. the second value of the second position parameter corresponds to the nominal value), a very efficient representation of the full three-dimensional position is achieved. Indeed, this can be achieved by communication of only a single value, and may indeed be achieved without any overhead being introduced whatsoever.

However, despite achieving such an efficient communication of positions when some of the values match nominal values, the approach is not limited to communication of positions for which these values do indeed match the nominal values. Rather, if a position is received for which the value of at least one of the second and third position parameters (variables) does not correspond to the nominal value, the output processor 609 inserts an invalid value in the first field. This provides a clear indication to the receiver that the current data does not represent the azimuth of a position, and thus informs the receiver that it cannot use the data of the first field to generate a position based on stored local nominal values. It thus provides a clear indication that a different approach should be taken in this scenario. Thus, under normal operation, a receiver will decode the data of the first field for the next position. If this is a valid value for the first position parameter (e.g. azimuth), it will know that the values for the second and first position parameters (e.g. elevation and distance) are identical to the nominal values. It therefore does not need any further information, and can proceed to generate the full three dimensional position. However, if the decoded value from the first field is not a valid value for the first position, it knows that at least one of the values of the second and third position parameters do not have the nominal value. Thus, the first field is used to provide a full three dimensional position in some cases, and to clearly indicate when it does not provide such a full three dimensional position. Thus, a receiver is informed by data in the first field whether it can proceed to generate a position based on the stored nominal values, or whether a different operation is necessary.

In situations where the first field contains an invalid position value for the first position parameter, the output processor 609 may proceed to follow the communication of the invalid value by data that describes the position. This data may be communicated in further data fields, i.e. a second, third etc. data field may be included in the bitstream by the output processor 609 for the current position. For example, after the communication of the invalid first parameter value (which indicates that the current position has different values than the nominal value for at least one of the second and third position parameters), the output processor 609 may proceed to transmit all three values of all three position parameters. These values may specifically be included in three subsequent data fields which may all have the same characteristics as the first data field. Thus, a first, second, third and fourth field may be provided.

For example, the section of the data stream defining a plurality of positions may simply comprise a series of identical data fields, each of which can contain a single value. The fields will contain an azimuth value for positions that have nominal distance and elevation values. Thus, a series of such positions can simply be represented by a single value (the azimuth value) in subsequent data fields (which will accordingly be first data fields for the positions). When a position is communicated which does not have the nominal value for either the distance or the elevation, the output processor 609 proceeds to first introduce an invalid azimuth value in a data field (the first data field for the position) and then follow this by three data fields with e.g. the next data field (which may be considered the second, third or fourth data field for the position) containing the azimuth value, the next data field (which may also be considered the second, third or fourth data field for the position) containing the elevation value and the next data field (which may also be considered the second, third or fourth data field for the position) containing the distance value.

Thus, a receiver will first receive the azimuth values and generate corresponding positions using the stored nominal values. However, when it detects an invalid azimuth, e.g. one that is outside the range of [0; 360°], it proceeds to discard this value and instead it determines the next position to have an azimuth given by the value of the following data field, an elevation given by the value of the next field, and a distance given by the value of the next data field.

The output processor 609, and indeed the receiver, then reverts to the normal operation, i.e. it assumes that the next field contains an azimuth value of a position with nominal values for the elevation and distance, unless the value is an invalid azimuth value in which case it proceeds to discard the value and read the next three fields to obtain the position.

The approach may thus provide an extremely efficient communication for positions having components/parameters that have nominal values, while at the same time not restricting the approach to such positions. Rather, it may allow any position to be communicated. Indeed, in the example, only one data field containing one value is needed for positions that have nominal elevation and distance values, and only four data fields are used for other positions. This results in a very significant overall data reduction in particular in applications where there is a high proportion of positions that have nominal values.

Such characteristics are very frequently found in audio applications. For example, most sound sources are considered to be in a horizontal plane, i.e. with typically a zero elevation angle, and to be at predetermined distances.

For example, HRTF filters are typically associated with a specific (virtual) source position that can be indicated by an azimuthal angle, elevation angle and a distance from the sweet-spot/listening position. Typically, but not necessarily, the distance is the same for all HRTF pairs in a set. Furthermore, HRTF pairs in an HRTF set are typically organized in a limited number of elevation angles with multiple azimuths per elevation angle, and indeed typically with more HRTF pairs for an elevation angle of zero than for other values. In such scenarios, the described approach can provide a very substantial reduction in data rate while still allowing all of the positions to be communicated. In particular, the approach can exploit the high degree of redundancy typically associated with transmission of position information for HRTF pairs while still allowing full flexibility for representing any position.

It will be appreciated that in some embodiments, the invalid value for the first position parameter (in the example, the azimuth value) may only be included once in the generated data stream. For example, the positions may be arranged such that all positions corresponding to nominal values for the second and third position parameters are communicated first. When these have all been communicated, the output processor 609 may transmit the invalid first parameter value in a first field for the next position to indicate that the next position, and indeed all positions from now on, does not have the nominal values for the second and third parameters. Thus, from then on the output processor 609 may transmit three fields for each position, i.e. a field for each position parameter may be provided for each position thereafter.

Specifically, the transmitter may first communicate all positions for a fixed nominal distance and a nominal value of 0°. These positions are communicated using only one data field for each position, i.e. only a first field is included for each position. After these positions, a data field may be inserted with an invalid value for the azimuth. Subsequently, the remaining positions are communicated using three data fields for each position, the first field providing the azimuth, the second field providing the elevation, and the third position providing the distance.

In the previous example, the invalid position value was a position outside of the range defined for the first position parameter, and specifically it was a value outside the defined range of the azimuth angle of [0; 360°]. It will be appreciated that other criteria may be used to determine whether a position value is a valid or invalid position value. Also, the criterion used to determine whether a value is valid or not need not be identical to the criterion applied when representing the first position parameter as a value, as long as the invalid position value used is one that may not be used to represent a first position parameter.

For example, if the first position parameter is an azimuth value, the criterion that an invalid position value is a value outside the range of [−180; 360°] may be used. Such a criterion can be used both for systems that represent the azimuth value as an angle in the range of [−180; 180°] and for systems that represent the azimuth value as an angle in the range of [0; 360°]. Thus, the same validity criterion can be used independently of which of the two representations are used to represent valid values of the azimuth value.

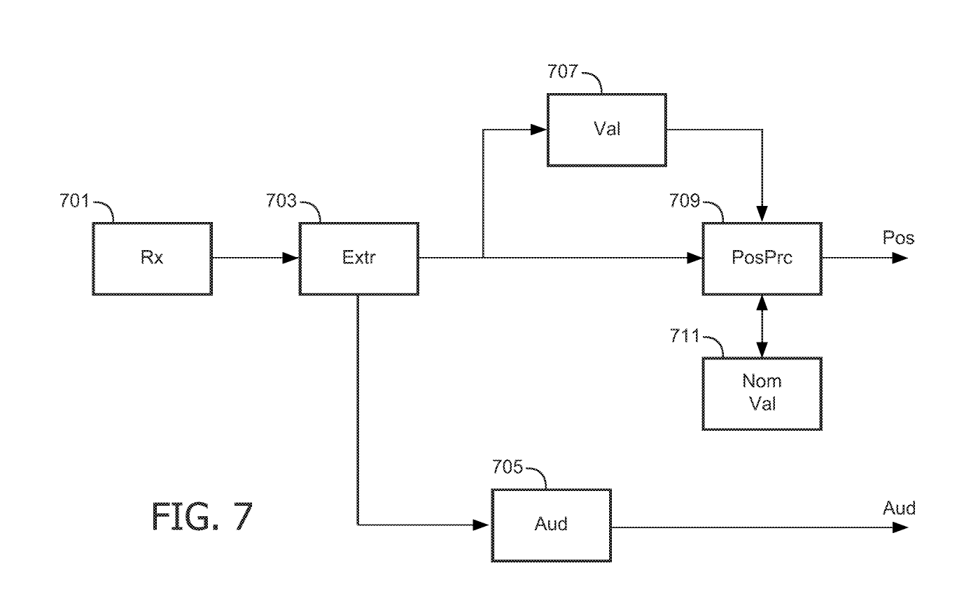

FIG. 7 illustrates an example of a receiver for receiving position information in accordance with some embodiments of the invention. In the example, the receiver is arranged to receive audio data as well as associated position information.

The apparatus of FIG. 7 comprises a receiver 701 which receives input data that comprises a plurality of fields. Specifically, the receiver 701 receives the data signal from the transmitter of FIG. 6.

The receiver is coupled to a data extractor 703 which is arranged to extract data from the received input data. The data extractor 703 can extract the audio data and feed it to an audio processor 705 which is arranged to generate audio output data. The audio processor 705 may for example include a suitable audio decoder.

The data extractor 703 is furthermore arranged to extract the data values of the sequence of data fields which contain the position information.

The data extractor 703 is coupled to a validity processor 707 which receives the extracted values. The validity processor 707 is arranged to check whether the received values represent a valid position value for the first position parameter. Thus, specifically, it can check whether a given received value corresponds to a valid azimuth or not. Thus, the validity processor 707 can generate a validity indication which indicates whether the current value is a valid azimuth value or not.

It will be appreciated that any suitable criterion or approach can be used to determine whether a value is a valid value or not. In the specific example, a valid range of values for azimuth is predefined and the validity processor 707 can simply detect whether the current value falls within this range or not. E.g. it can simply check whether the current value is within the interval of [0; 360°] (or e.g. [−180; 360°]).

The receiver of FIG. 7 further comprises a position processor 709 which is coupled to the data extractor 703 and the validity processor 707 and which receives the extracted values and the corresponding validity indications. The position processor 709 is further coupled to a nominal value store 711 in which the nominal values for the second and third position parameters are stored. Thus, in the specific example, the nominal distance and elevation values are stored. These values may (e.g. initially) be predetermined or predefined values, such as an elevation of 0° and a distance of 1.5 m.

The position processor 709 is arranged to recreate the original positions from the received position data. It does so by processing the data fields one at a time. Indeed, initially it may retrieve the value of the first field for the next position. If the validity indication from the validity processor 707 indicates that this is a valid value for the first position parameter, e.g. it is a valid azimuth value, then the position processor 709 proceeds to generate a position value which has this value for the first position parameter, e.g. the azimuth value of the position is set to the received (valid) azimuth value. It then proceeds to set the other position parameters to the nominal values, e.g. it may set the elevation value to the nominal elevation value of 0° and the distance value to the nominal distance value of 1.5 m. The three dimensional value is then output.

The position processor 709 may proceed to process the data fields in this way to generate output positions.

However, if a first field for a position comprises a data value for which the validity indication indicates that the value is not a valid value for the first position parameter, e.g. is not a valid azimuth value, then the position processor 709 proceeds to ignore the value as a value for the first position parameter, e.g. as an azimuth value. Instead it proceeds to evaluate other fields to determine the positions.

Indeed, in this case it may proceed to extract the value of the first position parameter from one field, and the value for the second position parameter from another field, and typically also the value for the third position parameter from yet another field. Thus, a second, third and fourth data field can be used to extract the position values.

As a specific example, the data field comprising the invalid azimuth value may be followed by three data fields comprising respectively a correct azimuth value, an elevation value and a distance value (either of the fields may be considered as the second, third and fourth data field for the position). Thus, in this case the position processor 709 generates the position from actual received data values in subsequent fields.

Thus, the receiver of FIG. 7 may decode the data from the transmitter of FIG. 6 such that the original positions are recreated. This may be achieved while allowing typically many values to be communicated by a single value, while still allowing a full flexibility in the characteristics of positions that can be communicated. Furthermore, a very simple data structure comprising a sequence of potentially identical fields can be used.

The resulting positions and audio signals may be fed to a renderer which can render the audio. For example, the renderer may perform a binaural rendering based on HRTF filters which are selected from the provided positions. Specifically, the positions may indicate desired positions of sound sources represented by the audio data, and the renderer may perform a rendering such that the sound sources are perceived to originate at the desired positions.

In the previous example, the nominal values were considered to be predetermined or predefined values. However, in many embodiments, the nominal value may advantageously be made variable. Specifically, both the output processor 609 of the transmitter of FIG. 6 and the position processor 709 of the receiver of FIG. 7 may be arranged to update the nominal value(s).

Specifically, when the match indication from the match processor 605 indicates that the value for the second position parameter does not match the nominal value, the output processor 609 may proceed to insert an invalid value for the first position parameter in the first field as described. It may then proceed to transmit the value for the second position to the receiver in a second field. However, in addition, it may set the stored nominal value for the second parameter to this value. Thus, in this way, the nominal value for the second parameter is updated and in addition the new value is communicated to the receiver.

When the position processor 709 detects that the validity indication indicates that the value received in the first field is not a valid value for the first position parameter, it proceeds to extract the value of the second data field. This will correspond to the new nominal value for the second position parameter and the position processor 709 will proceed to store this as the nominal value.

The output processor 609 of the transmitter may then proceed to process the current position again using the same standard approach. However, in this iteration, the match indication will indicate that the value of the second position parameter matches that of the stored nominal value (as it has just been set to this value in the previous iteration). Accordingly, it will proceed to insert the value of the first position parameter in the next data field. When this is received by the receiver the position processor 709 will proceed to generate the position from this data field but using the updated nominal value. Thus, the original position will be generated by the receiver.

The same approach may be used if the value for the third parameter does not match the nominal value for the third parameter.

The approach may allow a number of advantages. Indeed, a very efficient communication of many sets of positions can be achieved. Specifically, for sets where one position parameter varies frequently between positions whereas others do not can be communicated very efficiently. For example, the slowly varying position parameter can be set to a given nominal value, and all positions can then be communicated for this nominal value, possibly by only communicating a single value. The nominal value may then be updated and all positions for the newly updated nominal value may then be communicated, etc.

In addition, the approach allows for a low complexity approach. Indeed, all values of the first position parameter are transmitted by the same process, and are received by the same process. This process need not consider any other values. Rather, the system simply introduces two additional data fields that result in an update of the nominal value. E.g. a receiver may simply receive a data field and generate the position as the value of this data field and stored nominal values with the only exception being that from time to time a special invalid value is provided to indicate that the process should be temporarily interrupted to receive a new updated nominal value which is provided in the following data field.

In cases where there are a plurality of position parameters which utilize nominal values, the invalid value inserted in the data field to indicate that a different value follows may be selected to provide an indication of which of plurality of position parameters, the data relates to.

For example, if the position is given by three position parameters with nominal values being used for the second and third position parameters, the invalid value for the first position parameter may indicate whether the following value is a new value for the second position parameter or for the third position parameter. This may provide an efficient approach and provide more flexibility in how the nominal values are replaced and/or updated, and can typically be achieved without increasing the data rate.

As an example, in a scenario where each position is given by an azimuth, elevation and distance, the system may start with a predetermined nominal elevation and nominal distance which are known by both transmitter and receiver, such as e.g. an elevation of 0° and a distance of 1.5 meters. The positions may for example be sound source positions for use with HRTF binaural processing.

The transmitter may then start by communicating all positions for which the elevation is 0° and the distance is 1.5 meters. These positions are communicated simply by a sequence of azimuth values, with each new value representing a full three dimensional position which is recovered by the receiver by inserting the stored nominal values for elevation and distance.

When all these positions have been communicated, the next position will have a different elevation or distance. For example, the transmitter may proceed to communicate a number of positions with an elevation of 10°. The transmitter does this simply be inserting a value which is an invalid azimuth value (e.g. the value “510”) followed by a value representing the new elevation (i.e. representing “10°”). The receiver detects the invalid azimuth value and that this indicates that the next value is new nominal value for the elevation parameter. It then reads the next value and stores this as the nominal value for the elevation parameter. The transmitter then proceeds to transmit the azimuth for the positions with an elevation of 10°.

If the distance value is to be changed, the transmitter may simply insert another invalid azimuth value (e.g. the value “511”) to indicate that the next value is a distance value. Upon detecting this value, the receiver will read the next value and then proceed to store this as the nominal value for the distance.

Thus a very efficient communication of positions is achieved. Indeed, azimuth values are simply transmitted except for once in a while where a new nominal value for either the elevation or the distance is transmitted. The transmitter can use exactly the same approach for each azimuth value, and need only add an extra operation when the nominal values for the elevation or distance need to be changed. The approach may in particular exploit the typically limited variability of the elevation angles and distances while keeping full flexibility with respect to positioning.

In some embodiments, the invalid value for the first position parameter, e.g., the azimuth, may be used to provide an indication of a predetermined set of positions. In response to detecting a specific value of the invalid first position parameter value, the position processor 709 may proceed to extract a set of positions which are already known to the position processor 709.

For example, the transmitter and receiver may in advance agree upon a set of positions and an associated value of the first position parameter. E.g., a specific set of positions which should be extracted if the azimuth value has a specific value may be agreed upon e.g. via a previous data exchange, or simply via a general specification. For example, the value of “508” may be used to indicate that positions corresponding to a standard 5.1 speaker configuration should be generated by the receiver.

As another example, the value of the invalid azimuth value may indicate that the following data field will contain a value which selects one set of positions out of a plurality of sets of positions.

A very specific example of a possible syntax for such data is shown below:

| | No. of |
|---|---|
| Syntax | bits |
| Positions( ) | |
| { | |
| bsPositionConfig; | 4 |
| bsReserved; | 4 |
| switch (bsPositionConfig) { | |

| | | |
|---|---|---|
| | case 0: | /* Dynamic positions */ |
| | | (numPositions, azimuth, elevation, distance) = |
| DynamicPositions( ); | | |
| | | break; |
| | case 1: | /* 5.1 setup */ |
| | | numPositions = 5; |
| | | azimuth = [−110, −30, 0, 30, 110]; |
| | | elevation = [0, 0, 0, 0, 0]; |
| | | bsDistance = [100, 100, 100, 100, 100]; |
| | | break; |
| | case 2: | /* 6.1 setup */ |
| | | numPositions = 6; |
| | | azimuth = [−110, −30, 0, 30, 110 180]; |
| | | elevation = [0, 0, 0, 0, 0, 0]; |
| | | bsDistance = [100, 100, 100, 100, 100, 100]; |
| | | break; |
| | case 3: | /* 7.1 setup - SDDS */ |
| | | numPositions = 7; |
| | | azimuth = [−135, −45, −22.5, 0, 22.5, 45, 135]; |
| | | elevation = [0, 0, 0, 0, 0, 0]; |
| | | bsDistance = [100, 100, 100, 100, 100, 100]; |
| | | break; |
| | case 4: | /* 7.1 setup - 3/4.1 */ |
| | | numPositions = 7; |
| | | azimuth = [−110, −70, −30, 0, 30, 70, 110]; |
| | | elevation = [0, 0, 0, 0, 0, 0]; |
| | | bsDistance = [100, 100, 100, 100, 100, 100]; |
| | | break; |
| | case 5: | /* 7.1 setup - Dolby */ |
| | | numPositions = 7; |
| | | azimuth = [−150, −110, −30, 0, 30, 110, 150]; |
| | | elevation = [0, 0, 0, 0, 0, 0]; |
| | | bsDistance = [100, 100, 100, 100, 100, 100]; |
| | | break; |
| | case 6: | /* 22.2 setup - NHK */ |
| | | numPositions = 22; |
| | | azimuth = [−55, −27.5, 0, 27.5, 55, −90, 90, − |
| 135, 180, 135, | | |
| | | −55, 0, 55, −90, 0, 90, −135, 180, |
| 135, | | |
| | | −55, 0, 55]; |
| | | elevation = [0, 0, 0, 0, 0, 0, 0, 0, 0, 0, |
| | | 45, 45, 45, 45, 90, 45, 45, 45, 45, |
| | | −22.5, −22.5, −22.5]; |
| | | bsDistance = [400, 400, 400, 400, 400, 400, |
| 400, 400, 400, 400, | | |
| | | 400, 400, 400, 400, |
| 400, 400, 400, 400, 400, | | |
| | | 400, 400, 400]; |
| | | break; |
| } | | |

return (numPositions, azimuth, elevation, distance)
}

In some embodiments, the invalid value may indicate that a second field follows which comprises data that is indicative of a relative difference between pairs of positions. For example, the invalid value may indicate that the next data field comprises an angle difference between positions. The output processor 609 may then proceed to generate a set of positions which all have an azimuth difference of the given value, and an elevation and distance corresponding to the nominal value. In some embodiments, the data may also include an indication of an offset, whereas in other embodiments, a default offset may be assumed for the first value.

As an example, if the invalid value is, say, “509”, this may indicate that the following data field will include an indication of an azimuth angle difference. If the next data contains a value of, say “20°”, the position processor 709 may proceed to generate positions corresponding to the nominal values for elevation and distance and with azimuths of 0°, 10°, 20°, 30°, . . . 340°.

As a specific example, the following syntax may be used for a bitstream generated by the transmitter of FIG. 6:

| Syntax | | No. of bits | Mnemonic |
|---|---|---|---|
| DynamicPositions( ) | | | |
| { | | | |
| bsNumPositions; | | 9 | |
| p = 0; | | | |
| nrBits = 1; | | | |
| bsElevation = 0; | | | |
| bsDistance = 100; | | | |
| while (p < bsNumPositions) { | | | |
| bsPosVal; | | 10 | simsbf |
| nrBits += 10; | | | |
| if (bsPosVal == 509) { % | | | |
| Equally spaced speakers | | | |
| bsAziSpacing; | | 8 | uimsbf |
| bsNumSpaced; | | 9 | uimsbf |
| nrBits += 17; | | | |
| for (n = 0; n < bsNumSpaced; n++, | | | Note 1 |
| p++) { | | | |
| azimuth[p] = azimuth[p − 1] | | | |
| + bsAziSpacing; | | | |
| elevation[p] = bsElevation; | | | |
| distance[p] = bsDistance; | | | |
| } | | | |
| } elseif (bsPosVal == 510) { | % New | | |
| elevation | | | |
| bsElevation; | | 8 | simsbf |
| nrBits += 8; | | | |
| } elseif (bsPosVal == 511) { | % New | | |
| distance | | | |

| | |
|---|---|
| bsDistance; | 14 |
| nrBits += 14; | |
| } else { | |
| azimuth[p] = bsPosVal; | |
| elevation[p] = bsElevation; | |
| distance[p] = bsDistance; | |
| p = p +1; | |
| } | |
| } | |
| byteFill; | nrBits % |
| | 8 |

return (bsNumPositions, azimuth, elevation, distance);
}

In the above example, bitstream element bsPosVal corresponds to the first field and contains either an azimuth angle or an invalid azimuth value indicating that a different processing is required. When an azimuth code value of 510 is transmitted, a subsequent bitstream element bsElevation corresponds to a second field and contains an update value for the elevation. The same procedure holds for the distance using code value 511 and bitstream element bsDistance which in this case corresponds to a second field.

The syntax also allows further optimization by describing a succession of equally spaced azimuth angles by the spacing angle (bsAziSpacing) and the number of successive pairs (bsNumSpaced). Using the syntax, a grid of 72 speakers at 2 m distance and 0° elevation could be described by the following sequence of values.

| | | | | | | |
|---|---|---|---|---|---|---|
| 72 | 511 | 200 | −175 | 509 | 5 | 71 |

These values specifically indicate a grid of 72 speakers with 5° spacing at 2 m distance and 0° elevation.

Specifically, the bitstream in this examples starts with a field bsNumPositions indicating the number of positions that are provided. The field contains the number 72 which in accordance with the syntax indicates that positions for 72 speakers are being defined by the bitstream. Then follows a first data field, i.e. a field which may provide data for a new position. In accordance with the syntax, this field accordingly provides the bsPosVal data.

In the present case, the field contains the value 511, i.e. bsPosVal=511. This is an invalid value for the azimuth and thus indicates that other data is being provided and a different approach should be taken instead of just using the data as an azimuth value. As indicated in the syntax, bsPosVal=511 indicates that a new distance is being provided. In particular, it indicates that the next field (corresponding to a second field) comprises the value bsDistance which is the nominal value for the distance. In the present case, the next field contains the value 200, corresponding to the nominal distance bsDistance being set to 200 cm, i.e. to 2 m.

The next field is a first field and contains the value bsPosVal=−175. This value is a valid azimuth value and is not one of the reserved values. Accordingly, the azimuth value for the next position p (in this case p=0 as it is the first position) is set to this value azimuth[p]=bsPosVal. In addition, the elevation and distance are set to their nominal values:

elevation[p]=bsElevation;

distance[p]=bsDistance;

Thus, as the nominal distance has just been set to 2 meters, the distance for the position is set to 2 meters.

Then follows a new first field. In this case, the field contains the value 509, i.e. bsPosVal=509. This is an invalid value for the azimuth and thus indicates that other data is being provided and a different approach should be taken instead of just using the data as an azimuth value. As indicated in the syntax, bsPosVal=509 indicates that positions of a set of equally spaced speakers is being provided. In particular, it indicates that the next field comprises the value bsAziSpacing and that the next field comprises the value bsNumSpaced. The next field contains the value 5 and the following field contains the value 71, i.e. bsAziSpacing=5 and bsNumSpaced=71. This indicates that 71 positions are provide with the azimuth difference between each is 5°. The positions are given as

```
for (n = 0; n < bsNumSpaced; n++, p++) {
    azimuth[p] = azimuth[p − 1] + bsAziSpacing;
    elevation[p] = bsElevation;
    distance[p] = bsDistance;
}
```

i.e. each position is given the nominal elevation and distance and is offset 5° from the previous position. The loop is initiated by the previous position which was set to have an azimuth of −175°. Thus, a grid of 72 speakers with 5° spacing at 2 m distance and 0° elevation is provided.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc., do not preclude a plurality. Reference signs in the claims are provided merely as a clarifying example shall not be construed as limiting the scope of the claims in any way.

1. An audio encoder arranged to communicate a position, the audio encoder comprising:
a receiver for receiving a position, the position having at least a first value and a second value, the first value representing a first position parameter and the second value representing a second position parameter;
a match circuit for determining if the second value matches a nominal value for the second position parameter;
an output circuit for generating output data, the output circuit being arranged to:
when the second value matches the nominal value, including first data representing the first value in a first field of the output data but not including data representing the second value in the output data; and
when the second value does not match the nominal value, including second data in the first field, the second data representing an invalid position value for the first position parameter.

2. The audio encoder of claim 1 wherein the output circuit is arranged to, when the second value does not match the nominal value, include data representing the second value in a second field of the output data.

3. The audio encoder of claim 1 wherein the output circuit is arranged to, when the second value does not match the nominal value, set the nominal value to the second value.

4. The audio encoder of claim 1 wherein the output circuit is arranged to, when the second value does not match the nominal value, include data representing the first value in a third field of the output data.

5. An audio decoder for receiving a position given by at least a first value and a second value, the first value representing a first position parameter and the second value representing a second position parameter, the apparatus comprising:
a receiver for receiving input data comprising a plurality of data fields;
a data extractor for extracting first data from a first field of the plurality of data fields;
a validity circuit for determining if the first data represents a valid position value for the first position parameter;
a position circuit for determining the position, the position processor being arranged to:
when the first data represents a valid position value, determining the first value as the valid position value and the second value as a nominal value for the second position parameter; and
when the first data does not represent a valid position value, determining the second value from a second field of the input data.

6. The audio decoder of claim 5 wherein the position circuit is arranged to, when the first data does not represent a valid position value, set the nominal value to the second value.

7. The audio decoder of claim 5 wherein the first data is indicative of a type of data being provided in the second field of the output data.

8. The audio decoder of claim 5 wherein, when the first data does not represent a valid position value, the first data is indicative of the second field comprising an indication of a predetermined set of positions; and the position processor is arranged to determine at least the first value in response to the predetermined set of positions.

9. The audio decoder of claim 5 wherein the position is further given by a third value representing third position parameter and, when the first data does not represent a valid position value, the first data is indicative of whether the second field comprises a position value for the second position parameter or a position value for the third position parameter.

10. The audio decoder of claim 5 wherein, when the first data does not represent a valid position value, the first data is indicative of the second field comprises data indicative of a relative difference between pairs of at least three positions; and the position processor is arranged to determine at least the first value in response to the relative difference between pairs of at least three positions.

11. The audio decoder of claim 5 wherein the first position parameter is associated with a range of possible values and the invalid position value is a value outside the range.

12. The audio decoder of claim 5 wherein the second position parameter is one of a distance parameter and an elevation parameter.

13. The audio decoder of claim 1 wherein the position is at least one of:
a speaker position;
a sound source position; and
a virtual sound source position for a Head Related Transfer Function.

14. A method of an audio encoder communicating a position, the method comprising:
receiving a position, the position having at least a first value and a second value, the first value representing a first position parameter and the second value representing a second position parameter;
determining if the second value matches a nominal value for the second position parameter;
generating output data;
wherein generating the output data comprises:
when the second value matches the nominal value, including first data representing the first value in a first field of the output data but not including data representing the second value in the output data; and
when the second value does not match the nominal value, including second data in the first field, the second data representing an invalid position value for the first position parameter.

15. A method of an audio decoder receiving a position given by at least a first value and a second value, the first value representing a first position parameter and the second value representing a second position parameter, the method comprising:
receiving input data comprising a plurality of data fields;
extracting first data from a first field of the plurality of data fields;
determining if the first data represents a valid position value for the first position parameter;
determining the position;
wherein determining the position comprises:
when the first data represents a valid position value, determining the first value as the valid position value and the second value as a nominal value for the second position parameter; and
when the first data does not represent a valid position value, determining the second value from a second field of the input data.

16. An audio bitstream comprising audio data and a representation of a position given by at least a first value and a second value, the first value representing a first position parameter and the second value representing a second position parameter, the bitstream comprising a first data field, the first data field comprising data representing either:
the first value; or
an invalid position value for the first position parameter; and
the data signal only comprises data representing the second value if the first data field comprises the invalid position value.

17. A computer program product comprising computer program code means adapted to perform all the steps of claim 14 when said program is run on a computer.
